(19) United States
(12) Patent Application Publication
(10) Pub. No.: US 2010/0200356 A1
(43) Pub. Date: Aug. 12, 2010

(54) WET FRICTION PLATE

(75) Inventor: Kohei Dodo, Aichi-ken (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/701,904

(22) Filed: Feb. 8, 2010

(30) Foreign Application Priority Data
Feb. 12, 2009 (JP) JP2009-029715

(51) Int. Cl. F16D 13/60

(52) U.S. Cl. 192/107 R

(57) ABSTRACT

A wet friction plate includes a disc-shaped core plate; and a plurality of friction members arranged in a circle at intervals, on a surface of the core plate. A first oil groove is formed on a friction surface of at least one of the friction members, and the first oil groove communicates with only an inner peripheral side surface of the at least one friction member, which is closest to an inner periphery of the core plate among side surfaces of the at least one friction member. The first oil groove includes a circumferential groove that extends in a circumferential direction of the core plate, and at least one radial groove that extends in a radial direction of the core plate, and is connected to the circumferential groove, and that communicates with the inner peripheral side surface of the at least one friction member.

The disclosure of Japanese Patent Application No. 2009-029715 filed on Feb. 12, 2009 including the specification, drawings and abstract is incorporated herein by reference in its entirety.

### BACKGROUND OF THE INVENTION

1. Field of the Invention

The invention relates to a wet friction plate used as an engagement element of, for example, a wet multiplate clutch of an automatic transmission.

2. Description of the Related Art

In a wet multiplate clutch of an automatic transmission, if a large amount of oil is accumulated between a friction plate and a separator plate, which is a counterpart engagement element, when the clutch is in a disengaged state, torque is transmitted through the oil although the friction plate and the separator plate are away from each other. As a result, so-called drag torque is generated.

Accordingly, Japanese Patent Application Publication No. 9-72364 (JP-A-9-72364) describes a wet friction plate with a segment structure, in which a plurality of friction members 2 are arranged in a circle at predetermined intervals, on a surface of a disc-shaped core plate 1 as shown in FIG. 10. In a wet multiplate clutch that includes the wet friction plate with the segment structure, oil is discharged toward an outer peripheral side through gaps, each of which is formed between the adjacent friction members 20, due to a centrifugal force generated by rotation of the friction plate as shown by dashed arrows in FIG. 10. Thus, the generation of the above-described drag torque is suppressed.

Also, in the wet friction plate with the segment structure, part of the oil flows onto each friction member 2 as shown by arrows in FIG. 10 due to the rotation of the wet friction plate. Therefore, a thin oil film is formed on a friction surface of each friction member 2.

However, the oil is not sufficiently supplied to a portion of the friction member 2, which is far from an end portion onto which the oil flows due to the rotation of the friction plate. Thus, the oil film is not sufficiently formed in the portion of the friction member 2, which is far from the end portion of the friction member 2. For example, the oil is not sufficiently supplied to a portion X surrounded by a dashed line in FIG. 10, and the oil film is not sufficiently formed in the portion X. If the oil film is not sufficiently formed, when the wet friction plate wobbles and approaches the separator plate while the clutch is in the disengaged state, the friction member 2 directly contacts the counterpart engagement element, and accordingly, torque is instantaneously transmitted, and thus, vibrations and noise may occur.

### SUMMARY OF THE INVENTION

The invention provides a wet friction plate that allows oil to be easily discharged, that suppresses generation of drag torque, and that reduces the possibility that an oil film is not sufficiently formed on a friction surface of a friction member.

A first aspect of the invention relates to a wet friction plate that includes a disc-shaped core plate; and a plurality of friction members arranged in a circle at intervals, on a surface of the core plate. A first oil groove is formed on a friction surface of at least one of the friction members, and the first oil groove communicates with only an inner peripheral side surface of the at least one friction member, which is closest to an inner periphery of the core plate among side surfaces of the at least one friction member. The first oil groove includes a circumferential groove that extends in a circumferential direction of the core plate, and at least one radial groove that extends in a radial direction of the core plate, and is connected to the circumferential groove, and that communicates with the inner peripheral side surface of the at least one friction member.

With the above-described configuration, when the oil is discharged toward an outer peripheral side due to a centrifugal force generated by the rotation of the friction plate, the oil is supplied to the circumferential groove through the at least one radial groove. The first oil groove, which includes the circumferential groove, and the at least one radial groove, includes no opening portion except for an opening portion in the friction surface of the friction member and an opening portion in the inner peripheral side surface of the friction member. Therefore, the oil, which has been introduced into the first oil groove from the opening portion in the inner peripheral side surface of the friction member, flows onto the friction surface from the opening portion in the friction surface, and spills over the friction surface. As a result, the oil is supplied to a large area through the first oil groove, and the oil film is formed on the friction surface. This reduces the possibility that the oil film is not sufficiently formed on the friction surface.

That is, according to the above-described aspect, the oil is discharged through gaps each of which is formed between the adjacent friction members. In addition, the oil is supplied to a large area through the first oil groove, and thus, the oil film is formed in a large area of the friction surface. Thus, it is possible to allow the oil to be easily discharged, and to suppress the generation of drag torque. In addition, it is possible to reduce the possibility that the oil film is not sufficiently formed on the friction surface of the friction member.

When the friction plate is rotated, a shear force in a direction opposite to a rotational direction is applied to the oil film formed on the friction surface. Therefore, the oil, which forms the oil film, is moved on the friction surface so that the oil is stretched due to the rotation of the friction plate. In the above-described aspect, the friction surface is divided by the at least one radial groove. Therefore, the oil is moved a short distance so that the oil is stretched, as compared to the case where no radial groove is formed. Thus, viscosity resistance caused due to the movement of the oil is reduced.

That is, according to the above-described aspect, it is possible to reduce contact resistance caused by direct contact between the friction member and the counterpart engagement element by forming the oil film on the friction surface of the friction member. In addition, it is possible to reduce the viscosity resistance of the oil film, and to reduce the drag torque.

In the wet friction plate according to the above-described aspect, the first oil groove may include the paired radial grooves that are connected to respective end portions of the circumferential groove, and that communicate with the inner peripheral side surface of the at least one friction member.

In the case where the first oil groove is formed so that the paired radial grooves are connected to the respective end portions of the circumferential groove, and the paired radial grooves communicate with the inner peripheral side surface of the friction member as in the above-described configuration, the oil is supplied to the circumferential groove from the both end portions through the paired radial grooves. Therefore, the oil is supplied to the entire circumferential groove. Thus, the oil is supplied from the circumferential groove to a large outer peripheral portion of the friction member, which is close to the outer periphery of the core plate. Thus, in the above-described configuration, it is possible to effectively reduce the possibility that the oil film is not sufficiently formed in the outer peripheral portion of the friction member.

In the wet friction plate according to the above-described aspect, the first oil groove may further include the radial groove that is formed between the paired radial grooves, that is connected to the circumferential groove, and that communicates with the inner peripheral side surface of the at least one friction member.

With the above-described configuration, the oil is further supplied to the circumferential groove through the radial groove formed between the paired radial grooves. Also, the oil is supplied to a portion of the friction surface, which is located between the paired radial grooves, through the radial groove formed between the paired radial grooves.

Also, because the portion of the friction surface, which is located between the paired radial grooves, is divided by the radial groove between the paired radial grooves, it is possible to further reduce the viscosity resistance caused due to the movement of the oil on the portion of the friction surface, which is located between the paired radial grooves, when the friction plate is rotated.

In the wet friction plate according to the above-described aspect, a number of the at least one radial groove may be set according to a required transmission torque capacity; and as the required transmission torque capacity becomes larger, the number of the at least one radial groove may become smaller.

As the number of the at least one radial groove becomes larger, the oil is evenly supplied to a larger area of the friction surface. However, as the number of the at least one radial groove becomes larger, a contact area of the friction surface, which contacts the counterpart engagement element, becomes smaller, and accordingly, the torque, which can be transmitted when the friction surface contacts the counterpart engagement element, becomes smaller.

Therefore, the number of the at least one radial groove may be set according to the required transmission torque capacity; and as the required transmission torque capacity becomes larger, the number of the at least one radial groove may become smaller, as in the above-described configuration. By setting the number of the at least one radial groove according to the required transmission torque capacity, it is possible to ensure the required transmission torque capacity, and to reduce the possibility that the oil film is not sufficiently formed.

In the wet friction plate according to the above-described aspect, in the at least one friction member, at least one second oil groove may be formed on a portion of the friction surface, which is closer to the inner periphery of the core plate than the circumferential groove included in the first oil groove is; and the at least one second oil groove may communicate with only the inner peripheral side surface of the at least one friction member.

In the wet friction plate according to the above-described aspect, a number of the at least one second oil groove may be set according to a required transmission torque capacity; and as the required transmission torque capacity becomes larger, the number of the at least one second oil groove may become smaller.

With the above-described configuration, the oil is supplied directly to the portion of the friction surface, which is closer to the inner periphery of the core plate than the circumferential groove included in the first oil groove is, through the at least one second oil groove. Thus, it is possible to appropriately reduce the possibility that the oil film is not sufficiently formed.

In the case where the at least one second oil groove is formed, as the number of the at least one second oil groove becomes larger, the contact area of the friction member becomes smaller. Therefore, the number of the at least one second oil groove may be set according to the required transmission torque capacity; and as the required transmission torque capacity becomes larger, the number of the at least one second oil groove may become smaller, as in the above-described configuration. By setting the number of the at least one second oil groove according to the required transmission torque capacity, it is possible to ensure the required transmission torque capacity, and to reduce the possibility that the oil film is not sufficiently formed.

In wet friction plate according to the above-described aspect, a width of the first oil groove may be set according to a required transmission torque capacity; and as the required transmission torque capacity becomes larger, the width of the first oil groove may become smaller. A width of the first oil groove and a width of the at least one second oil groove may be set according to a required transmission torque capacity; and as the required transmission torque capacity becomes larger, the width of the first oil groove and the width of the at least one second oil groove may become smaller.

As the width of the oil groove becomes larger, a larger amount of oil is supplied to the friction surface, but the contact area of the friction surface, which contacts the counterpart engagement element, becomes smaller, and the torque, which can be transmitted when the friction member contacts the counterpart engagement element, becomes smaller.

Therefore, the width of the oil groove may be set according to the required transmission torque capacity; and as the required transmission torque capacity becomes larger, the width of the oil groove may become smaller as in the above-described configurations. By setting the width of the oil groove according to the required transmission torque capacity, it is possible to ensure the required transmission torque capacity, and to reduce the possibility that the oil film is not sufficiently formed.

In the wet friction plate according to the above-described aspect, the circumferential groove included in the first oil groove may be formed in an outer peripheral portion of the at least one friction member, which is closer to an outer periphery of the core plate than a center portion of the at least one friction member is.

The oil, which is supplied from an inner peripheral portion of the friction surface, is not likely to reach the outer peripheral portion of the friction surface of the friction member. Therefore, the oil film is not likely to be sufficiently formed particularly on the outer peripheral portion of the friction surface. As the circumferential groove included in the first oil groove becomes closer to an outer peripheral side surface of the friction member, which is close to the outer periphery of the core plate, the oil is more effectively supplied to the outer peripheral portion of the friction member through the circumferential groove. Therefore, it is possible to appropriately reduce the possibility that the oil film is not sufficiently formed. Accordingly, the circumferential groove may be formed at a position close to the outer peripheral side surface of the friction member. Thus, the circumferential groove may be formed in the outer peripheral portion of the friction member, which is closer to the outer periphery of the core plate than the center portion of the friction member is, as in the above-described configuration.

In the wet friction plate according to the above-described aspect, the first oil groove may be formed by press working. The first oil groove and the at least one second oil groove may be formed by press working. By forming the oil groove by press working, it is possible to easily form the oil grooves with the same shape in a large number of the friction members. Also, it is possible to reduce the possibility that the manufacturing cost is increased and the manufacturing process is made complicated by forming the oil groove.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a front view showing a friction plate according to an embodiment of the invention;

FIG. 2 is an enlarged view showing an enlarged portion A of the friction plate according to the embodiment shown in FIG. 1;

FIG. 3A is a sectional view taken along a line III-III in FIG. 2, and FIG. 3B is a sectional view showing a friction member for comparison;

FIG. 4 is a front view showing a friction member in a modified example;

FIG. 5 is a front view showing a friction member in a modified example;

FIG. 6 is a front view showing a friction member in a modified example;

FIG. 7 is a front view showing a friction member in a modified example;

FIG. 8 is a front view showing a friction member in a modified example;

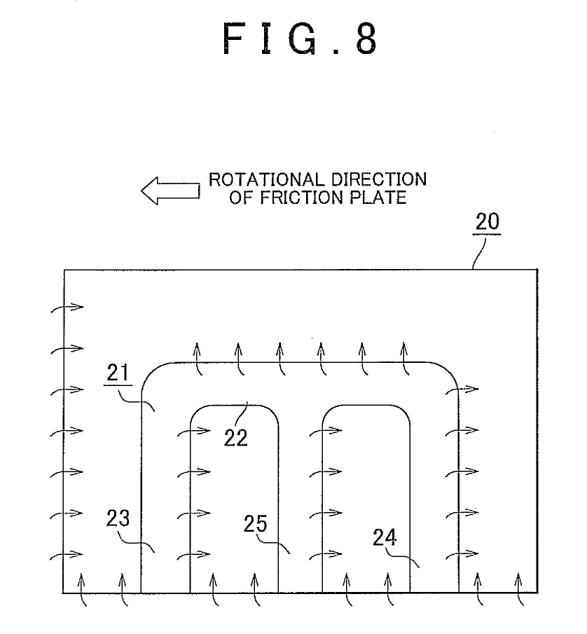

FIG. 9 is a front view showing a friction member in a modified example; and

FIG. 10 is a front view showing an enlarged portion including a friction member, in a conventional friction plate with a segment structure.

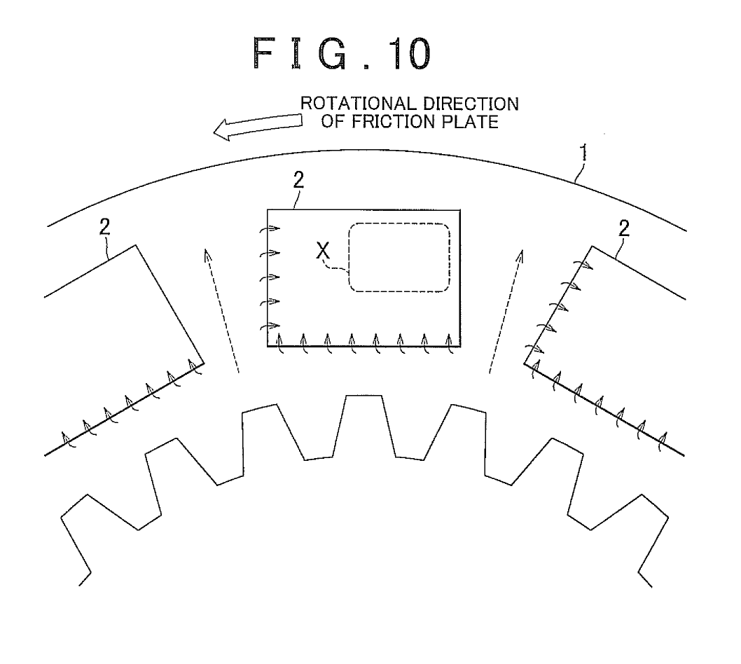

### DETAILED DESCRIPTION OF EMBODIMENTS

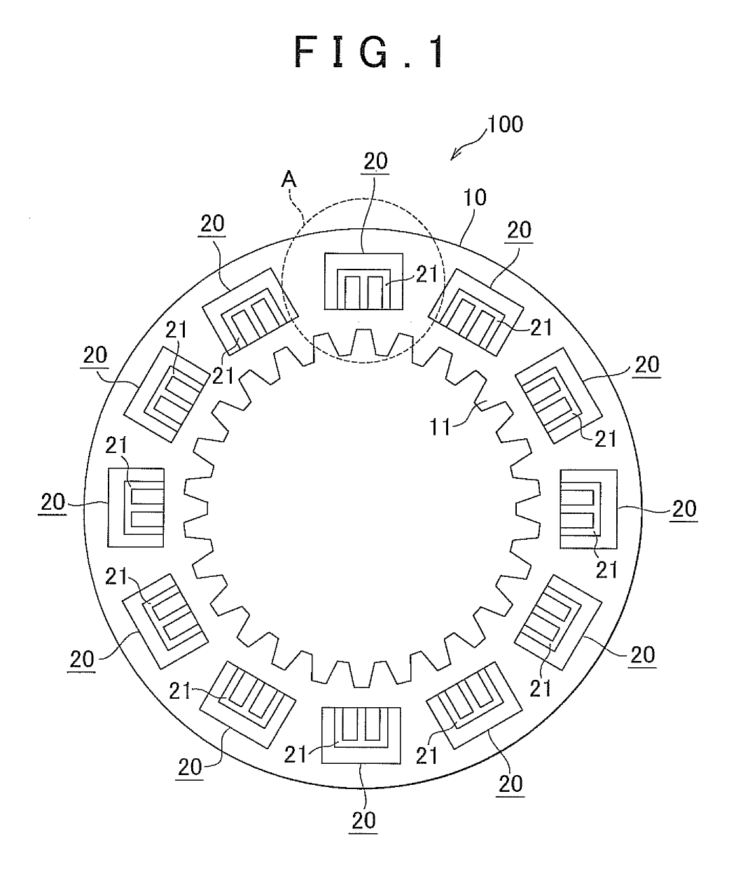

Hereinafter, an embodiment of the invention will be described with reference to FIG. 1 to FIGS. 3A and 3B. In the embodiment, a wet friction plate according to the invention is embodied as a friction plate employed in a wet multiplate clutch of an automatic transmission.

FIG. 1 is a front view showing a friction plate 100 according to the embodiment of the invention. As shown in FIG. 1, in the friction plate 100 according to the embodiment, twelve friction members 20 are arranged in a circle at regular intervals, on a surface of a disc-shaped core plate 10 made of metal. In the friction plate 100, twelve friction members 20 are similarly fixed to a reverse surface of the core plate 10.

As shown in FIG. 1, a spline 11 is formed on an inner periphery of the core plate 10. The spline 11 is engaged with a spline formed on an outer peripheral surface of a hub of an automatic transmission. Thus, the friction plate 100 according to the embodiment is fitted to the hub in a manner such that the friction plate 100 is not rotatable with respect to the hub, and is displaceable in an axial direction.

In the wet multiplate clutch of the automatic transmission, a plurality of the friction plates 100 fitted to the hub, and a plurality of separator plates are alternately arranged. Each separator plate is similarly fitted to an inner peripheral surface of a drum through a spline. Thus, the friction plates 100 and the separator plates constitute the clutch. When the friction plates 100 contact the separator plates due to an urging force of a hydraulic piston, the clutch is brought to an engaged state, and drive power is transmitted between the hub and the drum using a friction force generated between the friction plates 20 and the separator plates. When the transmission of the drive power is to be interrupted, the hydraulic pressure applied to the piston is reduced, and the friction plates 100 are moved away from the separator plates, and thus, the clutch is brought from the engaged state to a disengaged state.

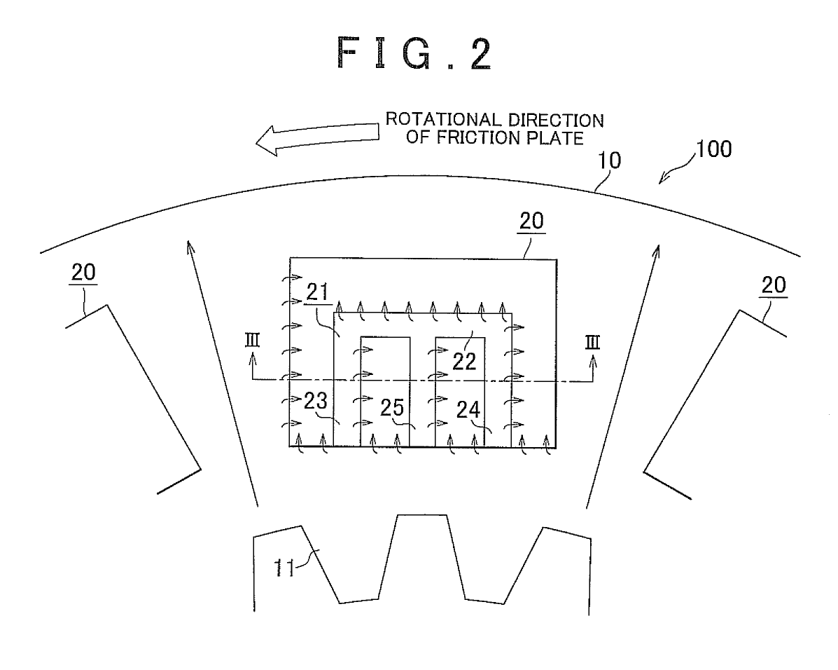

As shown in FIG. 1, an oil groove 21 is formed on a friction surface of each friction member 20 disposed on the surface of the core plate 10. The oil groove 21 may be regarded as the first oil groove according to the invention. Hereinafter, the oil groove 21 will be described in detail with reference to FIG. 2 that shows an enlarged portion A surrounded by a dashed line in FIG. 1.

As shown in FIG. 2, the oil groove 21 includes a circumferential groove 22 that extends in parallel with an outer peripheral side surface of the friction member 20, which is closest to an outer periphery of the core plate 10 among side surfaces of the friction member 20, and extends in a circumferential direction of the core plate 10. The circumferential groove 22 is formed in an outer peripheral portion of the friction member 20, which is closer to the outer periphery of the core plate 10 than a center portion of the friction member 20 is. A first radial groove 23 is connected to a left end portion of the circumferential groove 22 in FIG. 2. The first radial groove 23 extends in a radial direction of the core plate 10, and communicates with an inner peripheral side surface of the friction member 20, which is closest to an inner periphery of the core plate 10 among the side surfaces of the friction member 20. A second radial groove 24 is connected to a right end of the circumferential groove 22 in FIG. 2. The second radial groove 24 extends in the radial direction of the core plate 10, and communicates with the inner peripheral side surface of the friction member 20, as well as the first radial groove 23. Further, a third radial groove 25 is formed at a center position, that is, a position between the first radial groove 23 and the second radial groove 24, as shown in FIG. 2. The third radial groove 25 is connected to the circumferential groove 22. The third radial groove 25 extends in the radial direction of the core plate 10, and communicates with the inner peripheral side surface of the friction member 20.

Thus, in the friction plate 100 according to the embodiment, the oil groove 21 is formed in each friction member 20, and the oil groove 21 includes the circumferential groove 22, and the three radial grooves 23, 24, and 25. The width of the oil groove 21, and the number of the radial grooves connected to the circumferential groove 22 are set based on a required transmission capacity of the wet multiplate clutch that includes the friction plate 100 according to the embodiment. For example, the width of the oil groove 21, and the number of the radial grooves connected to the circumferential groove 22 are set based on results of experiment or the like conducted in advance so that the required transmission torque capacity is achieved, and an oil film is appropriately formed on the friction surface of the friction member 20.

As the width of the oil groove 21 becomes larger, and as the number of the radial grooves becomes larger, a larger amount of oil is supplied to the friction surface of the friction member 20, but a contact area between the friction member 20 and the separator plate, which is a counterpart engagement element, becomes smaller, and torque that can be transmitted becomes smaller. Therefore, as the required transmission torque capacity becomes larger, the width of the oil groove becomes smaller, and the number of the radial grooves becomes smaller.

The oil groove 21 is formed on the friction surface of each friction member 20 by press working. As described above, in the friction plate 100, a gap is formed between the adjacent friction members 20 disposed on the surface of the core plate 10. Therefore, when the clutch is in the disengaged state, the oil is discharged toward an outer peripheral side of the friction plate 100 through the gaps due to a centrifugal force generated by the rotation of the friction plate 100 as shown by arrows in FIG. 2. As a result, an amount of the oil between the friction plate 100 and the separator plate is reduced.

Also, because the oil groove 21 is formed on the friction surface of the friction member 20 as described above, when the oil is discharged toward the outer peripheral side due to the centrifugal force generated by the rotation of the friction plate 100, the oil is supplied to the circumferential groove 22 through the radial grooves 23, 24, and 25. The oil groove 21, which includes the circumferential groove 22, and the radial grooves 23, 24, and 25, includes no opening portion except for an opening portion in the friction surface of the friction member 20 and an opening portion in the inner peripheral side surface of the friction member 20. Therefore, the oil, which has been introduced into the oil groove 21 from the opening portion in the inner peripheral side surface of the friction member 20, flows onto the friction surface, and spills over the friction surface, as shown by the arrows in FIG. 2. Thus, an extremely thin oil film is formed on the friction surface of the friction member 20 by the oil that flows onto the friction surface from the oil groove 21, and the oil that flows onto the friction surface from the left side surface of the friction member 20 in FIG. 2 and the inner peripheral side surface of the friction member 20.

According to the embodiment that has been described above, it is possible to obtain the following advantageous effects. (1) When the oil is discharged toward the outer peripheral side due to the centrifugal force generated by the rotation of the friction plate 100, the oil is supplied to the circumferential groove 22 through the radial grooves 23, 24, and 25. The oil groove 21, which includes the circumferential groove 22, and the radial grooves 23, 24, and 25, includes no opening portion except for the opening portion in the friction surface of the friction member 20 and the opening portion in the inner peripheral side surface of the friction member 20. Therefore, the oil, which has been introduced into the oil groove 21 from the opening portion in the inner peripheral side surface of the friction member 20, flows onto the friction surface from the opening portion in the friction surface, and spills over the friction surface. As a result, the oil is supplied to a large area through the oil groove 21, and the oil film is formed on the friction surface. This reduces the possibility that the oil film is not sufficiently formed on the friction surface.

That is, in the friction plate 100 according to the above-described embodiment, the oil is discharged through gaps each of which is formed between the adjacent friction members 20. In addition, the oil is supplied through the oil groove 21, and thus, the oil film is formed in a large area of the friction surface. Thus, it is possible to allow the oil to be easily discharged, and to suppress the generation of drag torque. In addition, it is possible to reduce the possibility that the oil film is not sufficiently formed on the friction surface of the friction member.

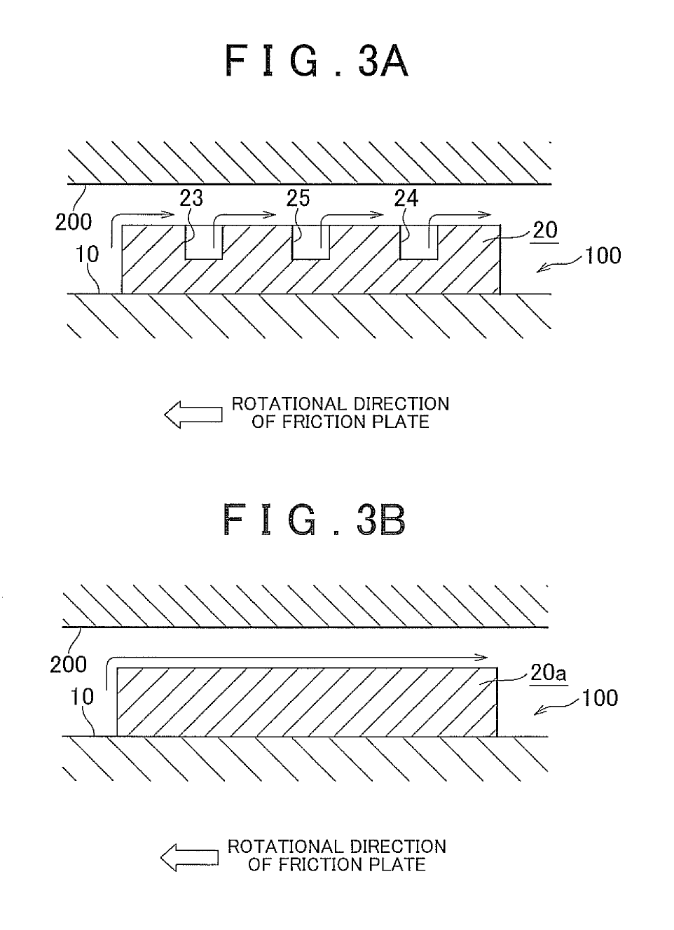

(2) When the friction plate 100 is rotated, a shear force in a direction opposite to a rotational direction is applied to the oil film formed on the friction surface. Therefore, the oil, which forms the oil film, is moved on the friction surface so that the oil is stretched due to the rotation of the friction plate 100, for example, when the friction plate 100 is close to a separator plate 200 as shown in FIG. 3A and FIG. 3B. FIG. 3A is a sectional view showing the friction member 20 taken along a line III-III in FIG. 2. FIG. 3B is a sectional view showing a friction member 20a on which the oil groove is not formed for comparison.

As shown in FIG. 3A, in the friction plate 100 according to the embodiment, the friction surface is divided by the radial grooves 23, 24, and 25. Therefore, the oil is moved a short distance so that the oil is stretched, as compared to the case where the radial grooves 23, 24, and 25 are not formed as shown in FIG. 3B. Thus, viscosity resistance caused due to the movement of the oil is reduced. That is, by forming the oil groove 21 on the friction member 20 as in the embodiment, it is possible to reduce the viscosity resistance of the oil, and to further reduce drag torque.

(3) In the oil groove 21, the paired radial grooves 23 and 24 communicate with the inner peripheral side surface of the friction member 20. The radial grooves 23 and 24 are connected to respective end portions of the circumferential groove 22. Therefore, when the friction plate 100 is rotated, the oil is supplied to the circumferential groove 22 from the both end portions of the circumferential groove 22 through the radial grooves 23 and 24. Therefore, the oil is supplied to the entire circumferential groove 22. Thus, the oil is supplied from the circumferential groove 22 to a large outer peripheral portion of the friction member 20, which is close to the outer periphery of the core plate 10. Accordingly, it is possible to effectively reduce the possibility that the oil film is not sufficiently formed in the outer peripheral portion of the friction member 20.

(4) The third radial groove 25 is formed between the paired radial grooves 23 and 24. Therefore, the oil is further supplied to the circumferential groove 22 through the third radial groove 25. Also, the oil is supplied to a portion of the friction surface, which is located between the paired radial grooves 23 and 24, through the third radial groove 25 formed between the paired radial grooves 23 and 24.

(5) The number of the radial grooves is set according to the required transmission torque capacity. As the required transmission torque capacity becomes larger, the number of the radial grooves becomes smaller. Therefore, it is possible to appropriately ensure the required transmission torque capacity, and to appropriately reduce the possibility that the oil film is not sufficiently formed.

(6) The width of the groove is set according to the required transmission torque capacity. As the required transmission torque capacity becomes larger, the width of the groove becomes smaller. Therefore, it is possible to appropriately ensure the required transmission torque capacity, and to appropriately reduce the possibility that the oil film is not sufficiently formed.

(7) The circumferential groove 22 is formed in the outer peripheral portion of the friction member 20, which is closer to the outer periphery of the core plate 10 than the center portion of the friction member 20 is. Therefore, it is possible to effectively supply the oil to the outer peripheral portion of the friction member 20, to which the oil would not be likely to be supplied if the circumferential groove 22 were not formed. Thus, it is possible to appropriately reduce the possibility that the oil film is not sufficiently formed.

(8) The oil groove 21 is formed by press working. Therefore, the oil grooves 21 with the same shape are easily formed in a large number of friction members 20. Thus, it is possible to reduce the possibility that the manufacturing cost is increased, and the manufacturing process is made complicated by forming the oil groove 21.

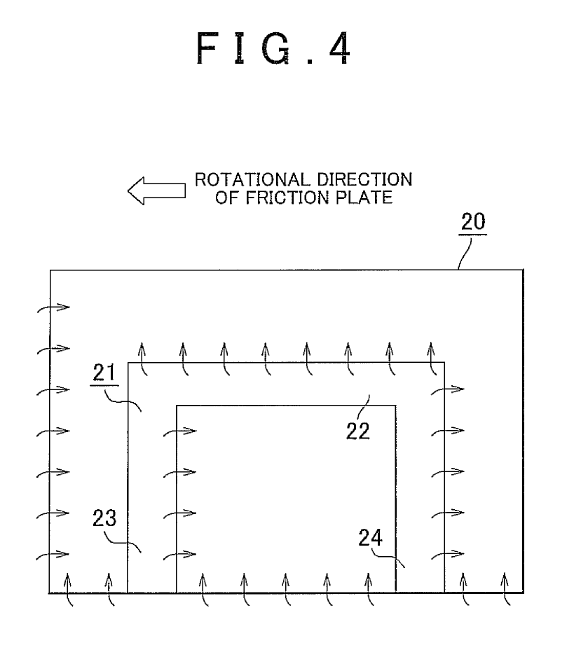

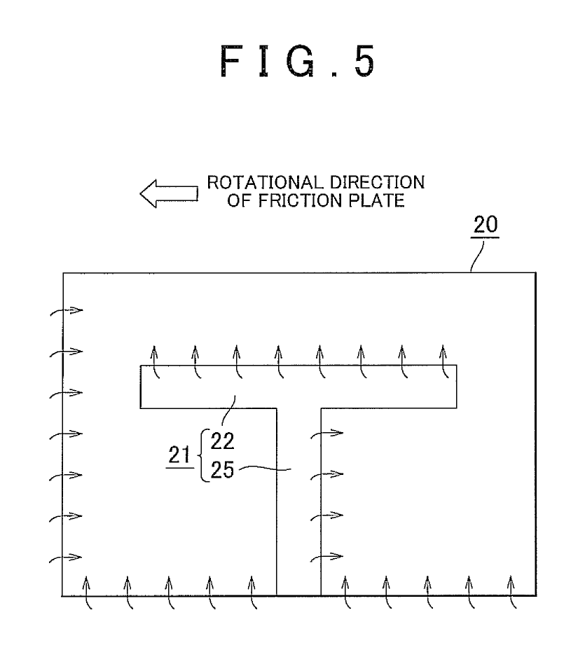

The above-described embodiment may be appropriately modified. The number of the radial grooves in the oil groove 21 may be appropriately changed. For example, as shown in FIG. 4, the third radial groove 25 may be omitted, and thus, two radial grooves may be formed. As shown in FIG. 5, the first radial groove 23 and the second radial groove 24 may be omitted, and one radial groove may be formed. Also, four or more radial grooves may be formed.

However, as the number of the radial grooves becomes larger, the contact area between the friction member 20 and the separator plate becomes smaller, and torque that can be transmitted becomes smaller. Therefore, the number of the radial grooves may be set according to the required transmission torque capacity as described above.

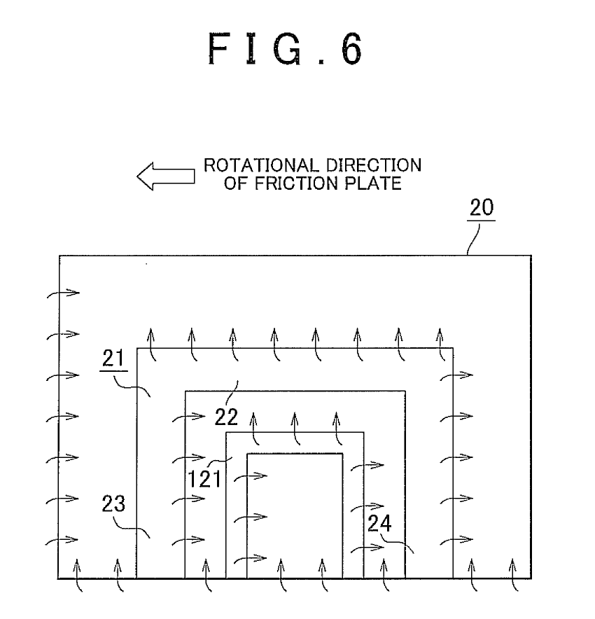

Also, as shown in FIG. 6, in addition to the oil groove 21, an oil groove 121, which is smaller than the oil groove 21, may be formed on a portion of the friction surface, which is closer to the inner periphery of the core plate 10 than the circumferential groove 22 included in the oil groove 21 is. With the configuration, the oil is supplied to the portion of the friction surface, which is closer to the inner periphery of the core plate 10 than the circumferential groove 22 included in the oil groove 21 is, through the oil groove 121 as shown by arrows in FIG. 6. Thus, it is possible to more evenly form the oil film on the entire friction surface.

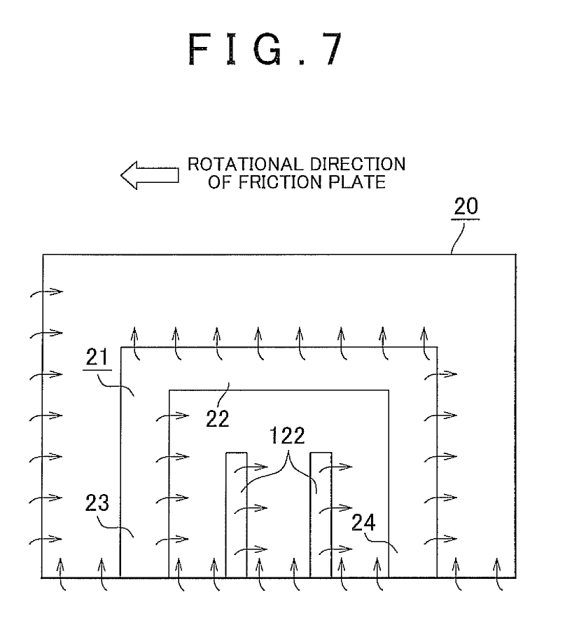

Also, as shown in FIG. 7, auxiliary oil grooves 122 may be formed on a portion of the friction surface, which is closer to the inner periphery of the core plate 10 than the circumferential groove 22 included in the oil groove 21 is. In this case, the auxiliary oil grooves 122 extend from the inner peripheral side surface of the friction member 20, and the auxiliary oil grooves 122 are not connected to the oil groove 21. With the configuration, the oil is supplied to the portion of the friction surface, which is closer to the inner periphery of the core plate 10 than the circumferential groove 22 included in the oil groove 21 is, through the auxiliary oil grooves 122 as shown by arrows in FIG. 7. Thus, it is possible to more evenly form the oil film on the entire friction surface. The oil groove 121 and the auxiliary oil grooves 122 may be regarded as the at least one second oil grooves according to the invention.

In the case where the oil groove(s) is (are) newly formed in addition to the oil groove 21, as the number of the additional grooves becomes larger, the contact area between the friction member 20 and the separator plate 200 becomes smaller. Therefore, the number of the oil grooves may be set according to the required transmission torque capacity, and as the required transmission torque becomes larger, the number of the oil grooves formed on the friction surface may become smaller. By setting the number of the oil grooves that are newly formed on the portion of the friction surface, which is closer to the inner periphery of the core plate 10 than the oil groove 21 is, it is possible to ensure the required transmission torque capacity, and to reduce the possibility that the oil film is not sufficiently formed.

The shape of the oil groove 21 is not limited to the above-described embodiment. The oil groove 21 may have any shape, as long as the oil groove 21 includes the circumferential groove that extends in the circumferential direction of the core plate 10, and the radial groove that extends in the radial direction of the core plate 10, and is connected to the circumferential groove, and that communicates with the inner peripheral side surface of the friction member 20. For example, the oil groove 21 may include a curved portion.

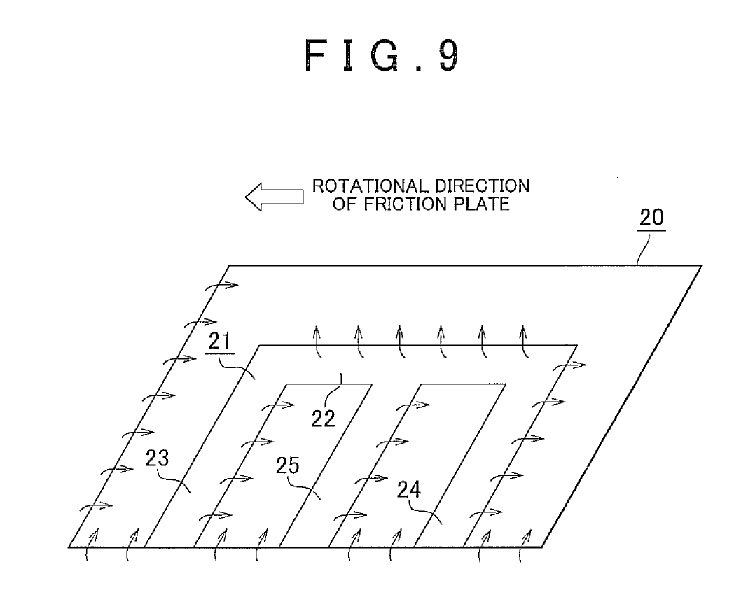

The shape of the friction member 20, in which the oil groove 21 is formed, is not limited to the shape in the above-described embodiment. For example, as shown in FIG. 9, the oil groove 21 may be formed in the friction member 20 with a parallelogram shape as shown in FIG. 9. In order to sufficiently supply the oil to the outer peripheral portion of the friction member 20, and to appropriately reduce the possibility that the oil film is not sufficiently formed, the oil groove 21 may be formed in accordance with the shape of the friction member 20 so that the oil is supplied as much as possible, to a peripheral portion of the friction member 20, as shown in FIG. 9. In other words, when the friction member 20 has a parallelogram shape, the radial groove may extend in parallel with two sides of the friction member 20.

In the above-described embodiment, the oil groove 21 is formed in each of all the friction members 20 as shown in FIG. 1. However, the oil groove 21 may be formed in at least one of the friction members 20.

In the above-described embodiment, in the friction plate 100, the spline 11 is formed on the inner periphery of the core plate 10. However, a spline may be formed on an outer periphery of the core plate 10. In the above-described embodiment, the friction members 20 are formed on both surfaces of the core plate 10. However, the friction members 20 may be formed on only one surface of the core plate 10.

Also, in the above-described embodiment, the twelve friction members 20 are formed on the surface of the core plate 10. However, the number of the friction members 20 formed on each of the surfaces of the core plate 10 may be appropriately changed.

In the above-described embodiment, the wet friction plate according to the invention is embodied as the friction plate employed in the wet multiplate clutch of the automatic transmission. However, the invention is not limited to the friction plate of the clutch. Therefore, the invention may be applied to any wet friction plate, as long as the wet friction plate is used in oil. For example, the invention may be applied to a wet friction plate employed in a brake.

What is claimed is:

1. A wet friction plate comprising:
a disc-shaped core plate; and
a plurality of friction members arranged in a circle at intervals, on a surface of the core plate, wherein
a first oil groove is formed on a friction surface of at least one of the friction members, and the first oil groove communicates with only an inner peripheral side surface of the at least one friction member, which is closest to an inner periphery of the core plate among side surfaces of the at least one friction member; and
the first oil groove includes a circumferential groove that extends in a circumferential direction of the core plate, and at least one radial groove that extends in a radial direction of the core plate, and is connected to the circumferential groove, and that communicates with the inner peripheral side surface of the at least one friction member.

2. The wet friction plate according to claim 1, wherein
the first oil groove includes the paired radial grooves that are connected to respective end portions of the circumferential groove, and that communicate with the inner peripheral side surface of the at least one friction member.

3. The wet friction plate according to claim 2, wherein
the first oil groove further includes the radial groove that is formed between the paired radial grooves, that is connected to the circumferential groove, and that communicates with the inner peripheral side surface of the at least one friction member.

4. The wet friction plate according to claim 1, wherein
a number of the at least one radial groove is set according to a required transmission torque capacity; and
as the required transmission torque capacity becomes larger, the number of the at least one radial groove becomes smaller.

5. The wet friction plate according to claim 1, wherein
the first oil groove includes a curved portion.

6. The wet friction plate according to claim 1, wherein
the at least one friction member has a parallelogram shape; and
the radial groove extends in parallel with two sides of the at least one friction member.

7. The wet friction plate according to claim 1, wherein
in the at least one friction member, at least one second oil groove is formed on a portion of the friction surface, which is closer to the inner periphery of the core plate than the circumferential groove included in the first oil groove is; and
the at least one second oil groove communicates with only the inner peripheral side surface of the at least one friction member.

8. The wet friction plate according to claim 7, wherein
the at least one second oil groove includes a circumferential groove that extends in the circumferential direction of the core plate, and at least one radial groove that extends in the radial direction of the core plate, and is connected to the circumferential groove included in the at least one second oil groove, and that communicates with the inner peripheral side surface of the at least one friction member.

9. The wet friction plate according to claim 7, wherein
the at least one second oil groove includes at least one radial groove that extends in the radial direction of the core plate, and communicates with the inner peripheral side surface of the at least one friction member, and that is not connected to the circumferential groove included in the first oil groove.

10. The wet friction plate according to claim 7, wherein
a number of the at least one second oil groove is set according to a required transmission torque capacity; and
as the required transmission torque capacity becomes larger, the number of the at least one second oil groove becomes smaller.

11. The wet friction plate according to claim 1, wherein
a width of the first oil groove is set according to a required transmission torque capacity; and
as the required transmission torque capacity becomes larger, the width of the first oil groove becomes smaller.

12. The wet friction plate according to claim 7, wherein
a width of the first oil groove and a width of the at least one second oil groove are set according to a required transmission torque capacity; and
as the required transmission torque capacity becomes larger, the width of the first oil groove and the width of the at least one second oil groove become smaller.

13. The wet friction plate according to claim 1, wherein
the circumferential groove included in the first oil groove is formed in an outer peripheral portion of the at least one friction member, which is closer to an outer periphery of the core plate than a center portion of the at least one friction member is.

14. The wet friction plate according to claim 1, wherein
the first oil groove is formed by press working.

15. The wet friction plate according to claim 7, wherein
the first oil groove and the at least one second oil groove are formed by press working.
